(19) United States
(12) Patent Application Publication
(10) Pub. No.: US 2013/0298806 A1
(43) Pub. Date: Nov. 14, 2013

(54) Weldless Aluminum Pallet

(71) Applicant: Eco Aluminum Pallets, LLC, Scottsdale, AZ (US)

(72) Inventors: Peter Johnson, Scottsdale, AZ (US); Rick Johnson, Mesa, AZ (US)

(21) Appl. No.: 13/946,745

(22) Filed: Jul. 19, 2013

Related U.S. Application Data
(63) Continuation of application No. 12/949,715, filed on Nov. 18, 2010, now abandoned.

(51) Int. Cl. B65D 19/08; B23P 15/00

(52) U.S. Cl. CPC B65D 19/08; B23P 15/00
USPC 108/56.1; 29/525.01

(57) ABSTRACT

A weldless aluminum pallet has slats that interlock with outside and inside stringers to form the pallet without need for permanent attachment points. Grooves in the stringers receive a projection on each slat, holding the slat in place. Preferably, a single projection extends along the length of the slat body. The projection is shaped to cooperate with the groove such that the slat attaches perpendicularly to the stringers. The groove is shaped to retain the slat's projection by friction fit, creating an interlocking joint. The front and rear slats on each face may be fastened to the stringers by screws or other removable fasteners. Pure aluminum or an aluminum alloy may be used, and the material may be tempered using known tempering techniques. The preferred material is 100% recycled 6005-T6 aluminum alloy. The parts are preferably extruded but alternatively may be molded or otherwise die cast.

### FIELD OF INVENTION

This invention relates to pallets. This invention relates particularly to an aluminum pallet that exceeds standard load-bearing requirements and is assembled without permanent attachment of the parts.

### BACKGROUND

The pallet is known to be the most commonly utilized structural base for transportation and storage of unit loads of goods. Pallet designs provide varying degrees of versatility with respect to the two main requirements of a pallet—bearing the weight of the load and being lifted by a jacking device, such as a forklift. Additional key aspects of a pallet design are ease of cleaning and sanitization, cost, expected useful life, reliability for reuse, and reparability.

Generally, size and load-bearing requirements for pallets are nationally and internationally standardized. A common variant in pallet designs is therefore the material from which the pallet is made, because the material type significantly affects ease of cleaning, cost, reusability, and reparability of the pallet. Known pallets are made of wood, paper, plastic, or certain metals including steel and aluminum. Due to their low cost, wood pallets are the most common. However, wood pallets suffer significant drawbacks. Relative to plastic and metal, wood is not strong and becomes weaker with age. The structural integrity of a wood pallet may be weakened when stored in excessively humid or dry conditions. A broken part on a wood pallet cannot be repaired, and may create dangerous splinters. Wood pallets can catch fire. Contact with liquids can damage or weaken a wood pallet, making it hard to clean. Wood pallets are subject to International Standards for Phytosanitary Measures No. 15 (“ISPM 15”), which requires specific treatments of wood to ensure that invasive insects, bacteria, or viruses are not present. These treatments increase the cost of the pallet and replacement parts and subject shippers to inspection violations if the wood does not meet the standard.

Certain plastic compounds are a marked improvement over wood as a pallet material. For example, high-density polyethylene is stronger and often lighter than wood, can be cleaned with liquids and acidic chemicals, and is not subject to ISPM 15. The plastic pallet may have a longer useful life. However, plastic also has drawbacks. A plastic pallet costs about 10 times the cost of a wood pallet. Plastic parts are generally not reparable. Plastic remains a fire hazard and is subject to deformation when stored in excessive heat or with heavy loads thereon.

Metal pallets are relatively new designs, currently comprising about 1% of in-use pallets. Known metal pallet designs use steel or aluminum to resolve many of the drawbacks of both wood and plastic, depending on the intended use. Both steel and aluminum are resistant to rust and degradation, can be cleaned and sanitized with liquids and acidic chemicals, are not subject to ISPM 15, and are stronger than wood and plastic. Metal pallets are fire resistant and may be reparable, depending on the damage. Metal pallets will not deform in heat or under heavy loads. Metal pallets are comparable or cheaper in cost than plastic, and may be cheaper than wood over the long run due to the longevity and durability of each pallet. One drawback of metal is its weight, and so aluminum is the preferred metal because it is significantly lighter than steel of comparable size.

While aluminum is proving to be the preferred pallet material, the few known designs suffer the common drawback of being assembled using one of two fastening mechanisms: screws or welding. Screw-attachment designs are deficient due to the number of screws required for secure attachment of slats to stringers. Each slat needs at least two screws at each attachment point to each stringer. For a typical 40 inch pallet with 7 5-inch slats and 3 stringers, this equates to six holes in each slat, 14 holes in each stringer, and 52 screws. Such a design incurs significant manufacturing and assembly costs. Similar cost issues plague welded designs, which require the expensive services of a professional welder to assemble or repair the pallets. While the problem of missing screws is resolved, a new issue arises in that welds are permanent attachments. Thus, a welded pallet cannot be disassembled and is not easily repaired. An aluminum pallet design that is equally reliable, but less expensive to manufacture, assemble, and disassemble compared to existing aluminum pallets is needed.

Therefore, it is an object of this invention to provide an aluminum pallet that may be assembled without permanent fasteners. It is a further object that the pallet be assembled with a minimum of removable fasteners. It is a further object that the pallet be formed of interlocking parts. Another object of the invention is to provide a pallet that meets the size and load-bearing standards of the pallet industry, is fireproof and rustproof, can be easily cleaned and sanitized, and can be assembled and disassembled with ease.

### SUMMARY OF THE INVENTION

The present invention is an aluminum pallet having interlocking parts that allow assembly of the pallet into its production form without the need for permanent attachment points, such as welds. Further, the aluminum pallet is assembled using a minimum of removable fasteners, preferably screws. Pure aluminum or an aluminum alloy may be used, and the material may be tempered using known tempering techniques. The preferred material is 100% recycled 6005-T6 aluminum alloy. The parts are preferably extruded but alternatively may be molded or otherwise die cast.

The parts include a plurality of slats attached to a plurality of stringers, selected to form the desired stringer design pallet. Preferably, the parts form a double-face or reversible pallet. A slat has a body with a top surface, on which goods are placed, and a bottom surface; and at least one projection extending from the bottom surface of the body. Preferably, a single projection extends along the length of the slat body. The projection is shaped to cooperate with a groove formed into each stringer, such that the slat attaches perpendicularly to the stringers. The groove is shaped to retain the slat's projection by friction fit, creating an interlocking joint. The groove and projection may have any interlocking cross-sectional shape. Each stringer has as many grooves as the pallet has slats. Two of the stringers are outside stringers, each outside stringer having one or two lips projecting vertically from the outside edge of the stringer. The lips are abutted by the slats when the slats are in place, preventing the slats from extending past the outside edge of the outside stringers. The remaining stringers are inside stringers, which may be attached by fasteners to the slats at a desired distance from the outside stringers.

Methods of making a weldless aluminum pallet are also disclosed. First, slats and stringers having the above-described features are extruded from extrusion dies. Preferably, the grooves are formed into the stringers after extrusion. Three extrusion dies are needed—one each for the slat, the outside stringer, and the inside stringer. The outside stringer has one lip if the pallet is single-faced, and two lips if the pallet is double-faced or reversible. After extrusion, the parts are cut to the desired length. The grooves are then formed into each stringer, preferably uniformly spaced along the length of the stringer, by drilling. The first slat is taken up and its projection is inserted at the slat's proximal end through corresponding grooves in the inside stringers, and then into the corresponding groove in the first outside stringer until the slat body abuts the lip on the first outside stringer. The insertion is repeated with each slat, and then the second outside stringer is placed onto the slats' projections at the slats' distal ends. The stringers are then fastened to the front and back slats to finish the pallet.

### BRIEF DESCRIPTION OF THE DRAWINGS

FIG. 1 is a top perspective view of the preferred embodiment of the pallet.

FIG. 2 is a top view of the pallet of FIG. 1.

FIG. 3 is a top perspective view of an alternative embodiment of the pallet.

FIG. 4 is a bottom left perspective view of the preferred slat.

FIG. 5A is a front cross-sectional view of the preferred slat taken along line 5-5 of FIG. 4.

FIG. 5B is a front cross-sectional view of an alternative slat.

FIG. 6 is a top left perspective view of the preferred outside stringer.

FIG. 7A is a front cross-sectional view of the preferred outside stringer configured for a light-duty pallet, taken along line 7-7 of FIG. 6.

FIG. 7B is a front cross-sectional view of the preferred outside stringer configured for a heavy-duty pallet, taken along line 7-7 of FIG. 6.

FIG. 8 is a left side view of the preferred outside stringer.

FIG. 9 is a top left perspective view of the preferred inside stringer.

FIG. 10A is a front cross-sectional view of the preferred inside stringer configured for a light-duty pallet, taken along line 9-9 of FIG. 9.

FIG. 10B is a front cross-sectional view of the preferred inside stringer configured for a heavy-duty pallet, taken along line 9-9 of FIG. 9.

FIG. 11 is a flowchart illustrating the preferred method of making the pallet.

### DETAILED DESCRIPTION OF THE INVENTION

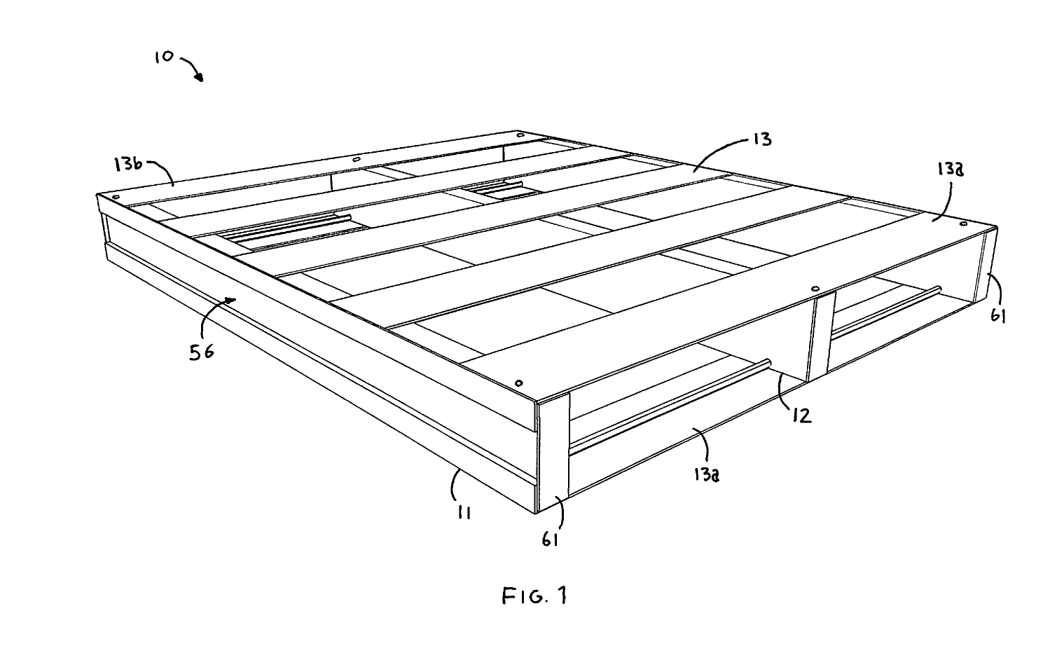

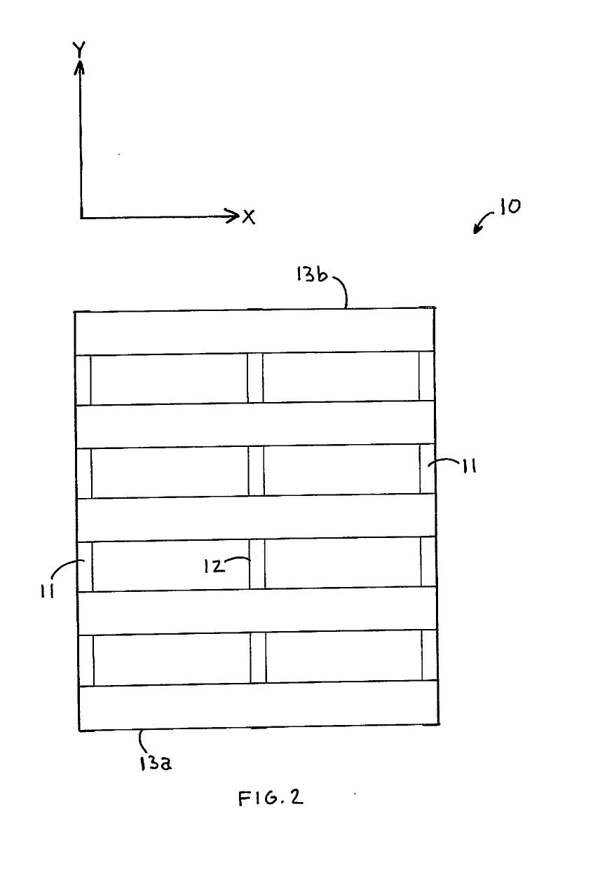

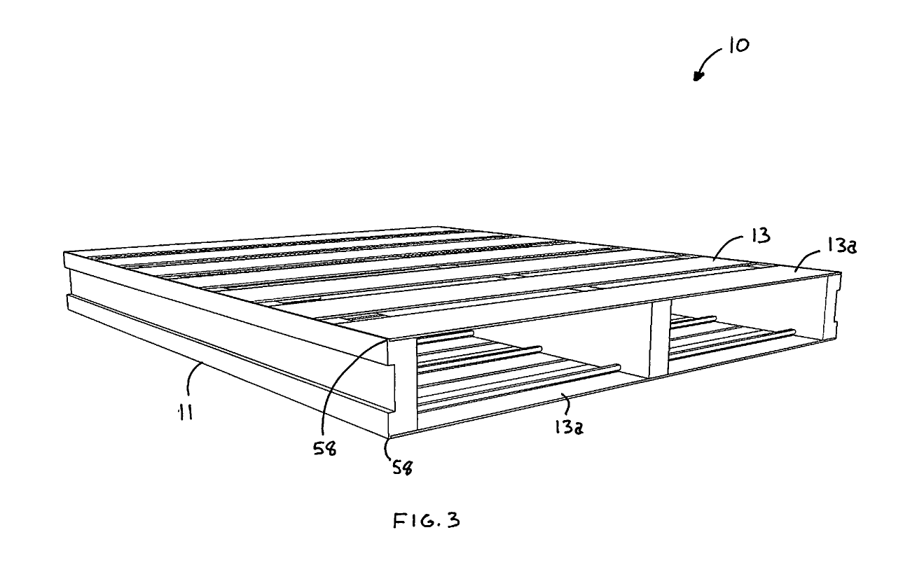

Referring to FIGS. 1 and 2, there is illustrated the preferred embodiment of the present invention, designated generally as 10, which is a weldless aluminum pallet comprising interlocking parts. The pallet 10 generally may have any design known in the industry as a “stringer design,” in that the pallet 10 has at least two outside stringers 11 and at least one inside stringer 12, to which a plurality of slats 13 are attached. By way of example, the possible pallet 10 designs may include: single-faced, in which slats 13 are arranged to form a top load-bearing face, and the opposite or “bottom” slats 13, if any, do not form a load-bearing face; double-faced, in which slats 13 are arranged to form top and bottom load-bearing faces; and reversible, in which the pallet 10 is double-faced and the top and bottom faces are identical. The faces are substantially planar in a plane parallel to the plane defined by lines X and Y in FIG. 2. Any pallet 10 design may further be flush, having slats 13 that do not hang over the outer edges of the outside stringers 11; or winged, having top slats 13 or top and bottom slats 13 extending beyond the outer edges of the outside stringers 11. The preferred pallet 10 is a double-faced pallet 10 having 1 inside stringer 12, 5 top slats 13 and 3 bottom slats 13. A reversible pallet 10 having 7 top slats 13 and 7 bottom slats 13 is shown in FIG. 3. The designs shown in FIGS. 1-3 are flush pallets 10. The dimensions of the pallet 10 are chosen to conform to a standardized pallet size. The preferred embodiment conforms to the international standard of 48 inches by 40 inches, wherein 48 inches is the stringer 11, 12 length. The pallet 10 may have any desired height, typically chosen according to the desired use, but preferably the height is between 4 and 5 inches.

The present inventive pallet 10 is made of aluminum, which may be pure aluminum or an aluminum alloy. Preferably, the material is 6005-T6 aluminum alloy, representing the most favorable combination of strength and cost-effectiveness. The selection of aluminum alloyed with magnesium and silicon is easier to extrude than other alloys, and can be hardened to near-steel strength. Other alloys and degrees of tempering may be used. The preferred alloy allows the parts of the pallet 10 to be extruded with a wall thickness of as thin as 0.094 inches. Because the weight of the pallet 10 is a significant concern, the present invention contemplates a preferred heavy-duty and a preferred light-duty design. The preferred heavy-duty pallet 10 has stringers 11, 12 with 0.125 inch thick walls. The preferred light-duty pallet 10 has stringers 11, 12 with vertical walls that are 0.094 inches thick. The horizontal exterior walls of the light-duty stringers 11, 12 remain at 0.125 inches thick in order to receive the neck of the slats' 13 projections as described below. Further, the light-duty stringers 11, 12 may be up to an inch shorter than the heavy-duty stringers 11, 12 to further reduce the weight of the pallet 10. The light-duty pallet 10 may be about 50%-80% of the weight of the heavy-duty pallet, most preferably about 75%, depending on the chosen pallet design.

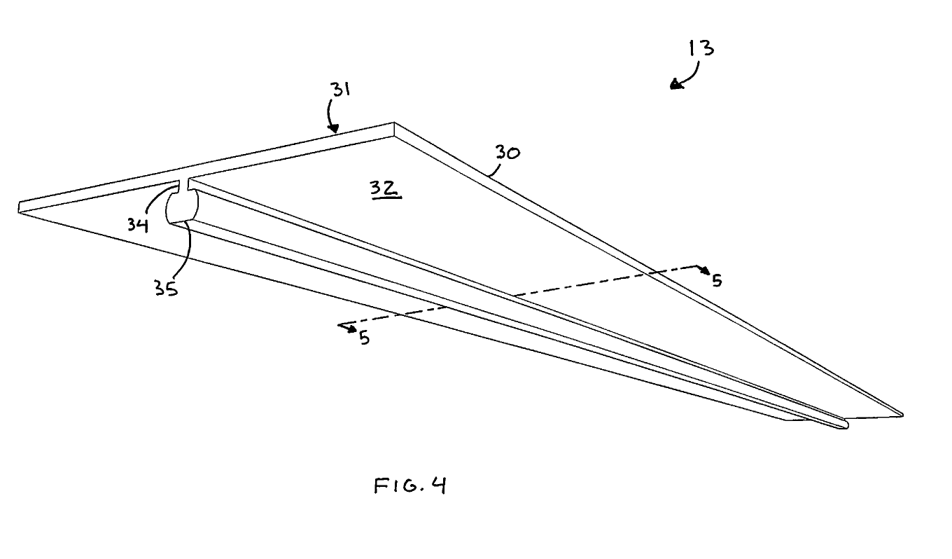

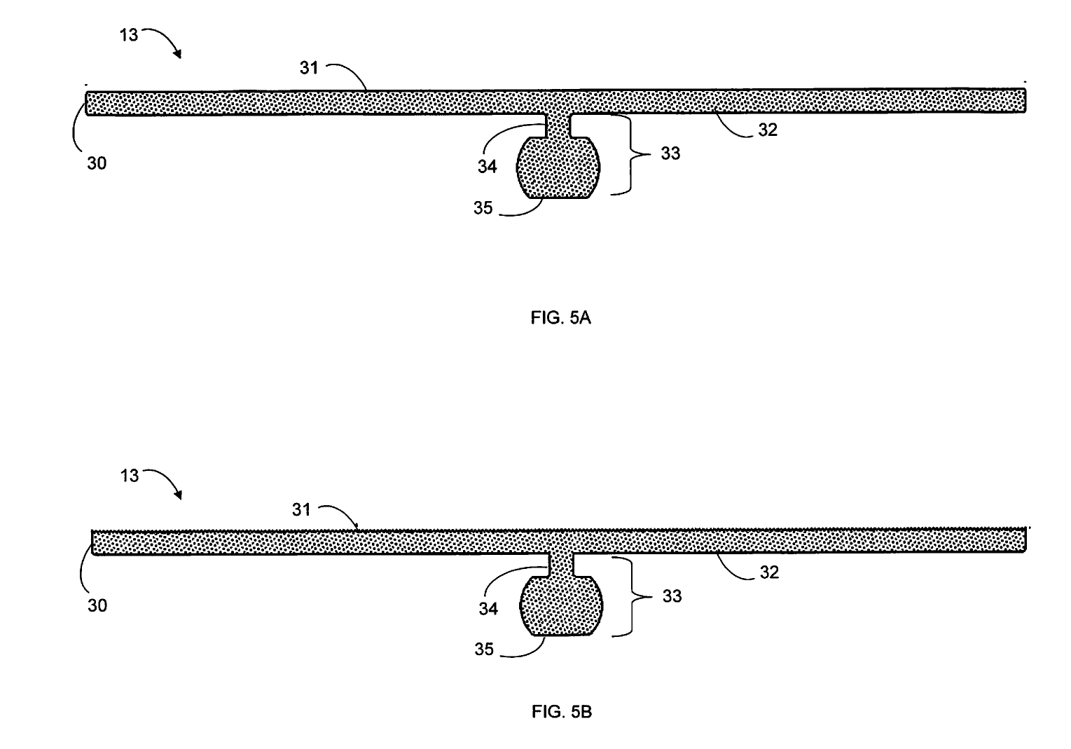

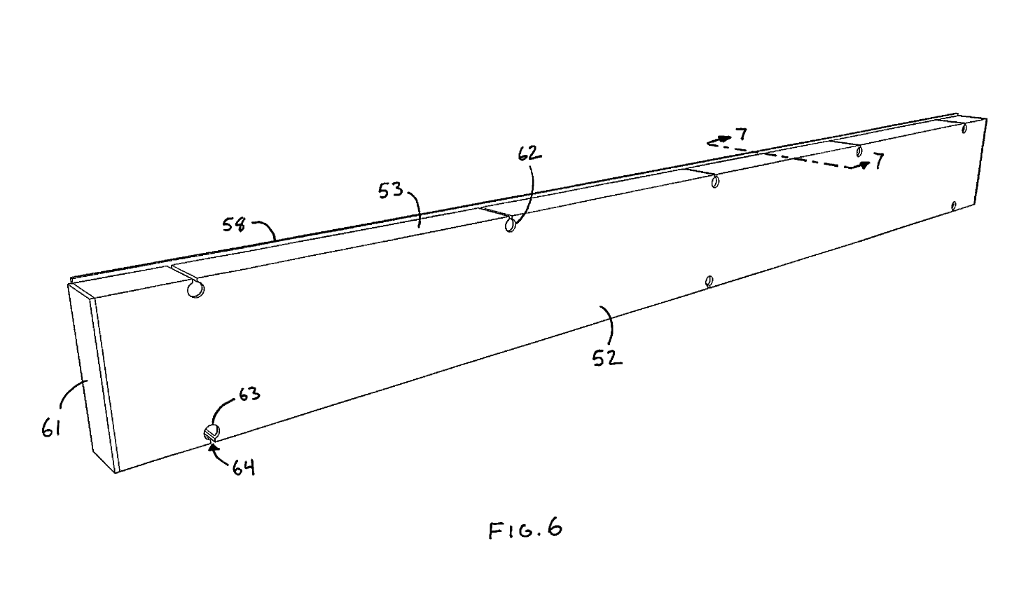

Referring to FIGS. 4, 5A, and 5B, the slat 13 comprises a slat body 30 having an outer surface 31 and an inner surface 32. The outer surface 31 represents a portion of the top or bottom face of the pallet 10; that is, the outer surfaces 31 of all of the top slats 13 form the top face of the pallet 10, and the outer surfaces 31 of all of the bottom slats 13 form the bottom face of the pallet 10. The outer surface 31 is substantially flat and may be planar, as shown in FIG. 5A. The outer surface 31 may alternatively be textured to increase the amount of friction between the face of the pallet and the goods placed thereon. The outer surface 31 may be serrated, as shown in FIG. 5B, or ribbed, or have nodes or treads formed thereon. Preferably, the texture is one that can be formed during the extrusion process, as in the serration shown in FIG. 5B. Alternatively, the texture may be added to the outer surface 31 after the extrusion process, such as by applying a textured coating. The inner surface 32 is planar and contacts the stringers 11, 12 when the pallet 10 is formed. The slat body 30 may have any dimensions conducive to forming the pallet. The preferred height is 0.125 inches, giving the preferred slat 13 sufficient load-bearing capacity. The preferred width is about 5 inches. The length of the slat body 30 depends on whether the pallet 10 is flush or winged, with the preferred slat body 30 measuring 39.75 inches in length.

At least one projection 33 extends out from the inner surface 32 substantially perpendicularly to the inner surface 32. Preferably, there is 1 projection 33 centrally located on the top surface 32. The projection 33 is preferably integral with the slat body 30 and is extruded together with the slat body 30. The projection 33 comprises a neck 34 connected to the top surface 32, and a tongue 35 connected to the neck 34. The projection 33 is configured to cooperate with a groove formed into the stringers 11, 12 as described below, such that the slat 13 interlocks with the stringers 11, 12 to form the pallet 10. Preferably, the neck 34 is about 0.125 inches square in cross-section. The tongue 35 is substantially wider than the neck 34, having a cross-sectional shape that provides substantial contact with the surfaces of the groove in each stringer 11, 12 to hold the slat 13 securely to the stringers 11, 12. The preferred cross-sectional shape of the tongue 35 is illustrated in FIGS. 5A-B, being a circle having a radius of about 0.219 inches, with segments removed from the top and bottom of the circle so that the height of the tongue 35 is about 0.313 inches. The preferred height of the projection 33 is therefore about 0.438 inches.

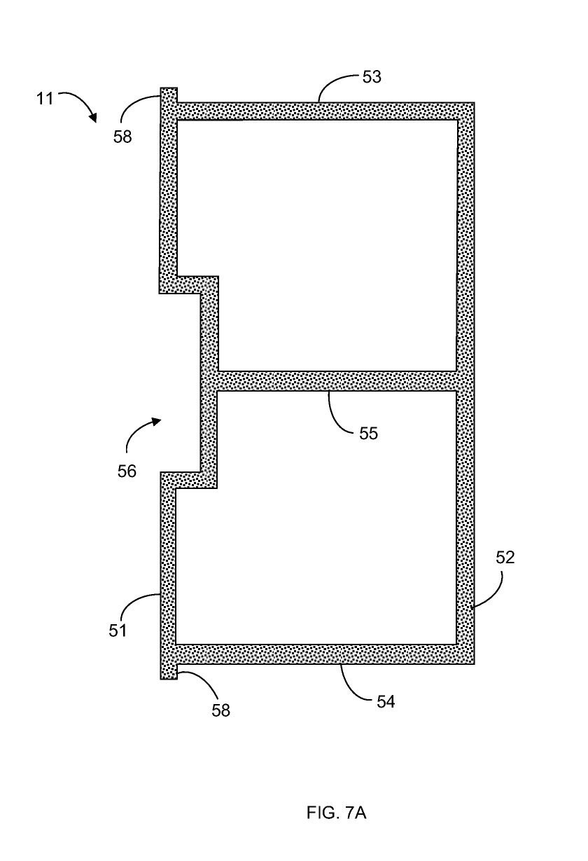

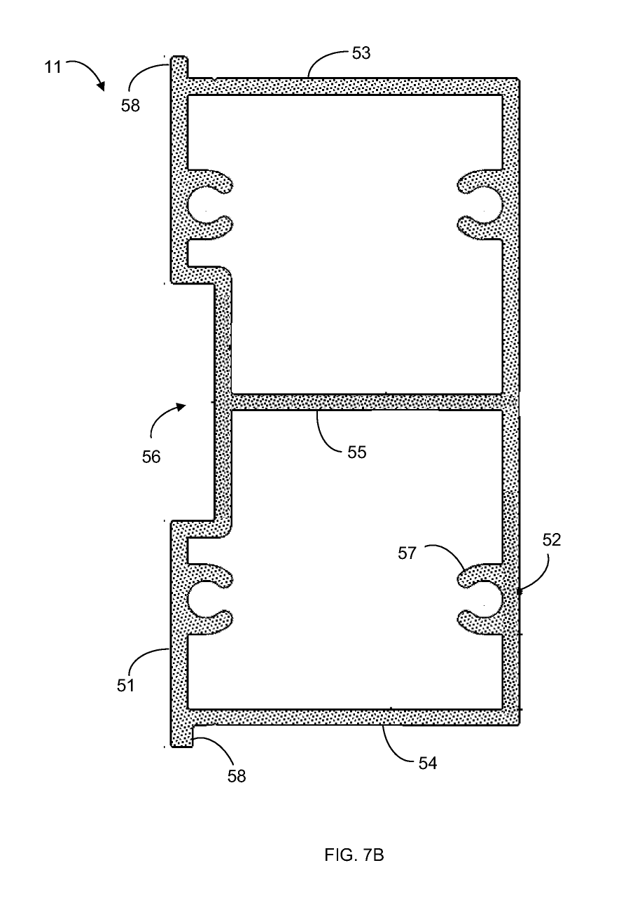

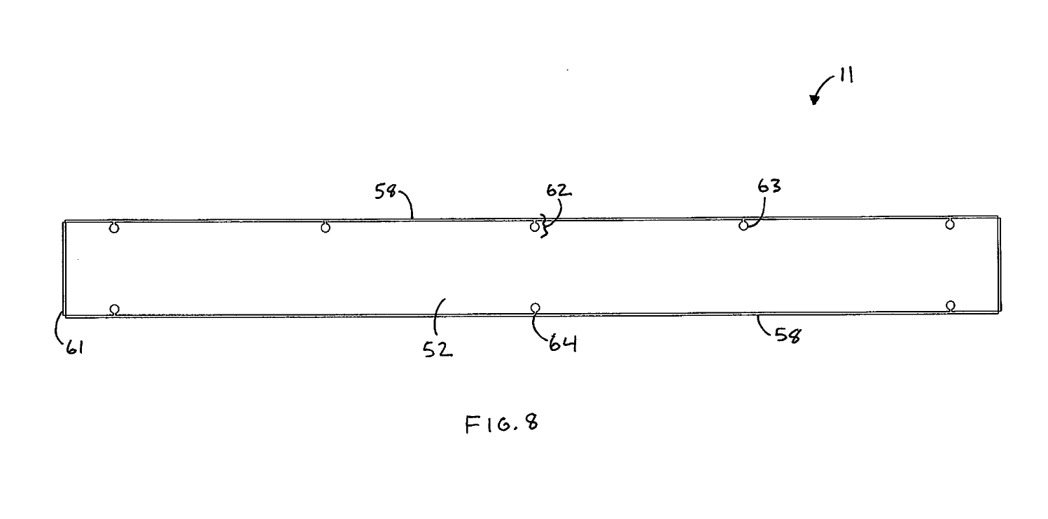

FIGS. 6-8 illustrate the preferred outside stringer 11. The outside stringer 11 has two vertical walls—an outside wall 51 and an inside wall 52. A horizontal top wall 53 and horizontal bottom wall 54 connect the outside wall 51 to the inside wall 52, leaving the outside stringer 11 substantially hollow. It will be understood that for double-faced, reversible, and double-winged pallets 10, the top wall 53 and bottom wall 54 are interchangeable; that is, the outside stringer 11 is symmetrical about the midpoint of the vertical walls, so “top” and “bottom” merely identify the wall and do not require one wall to be disposed above or below the other. The outside stringer 11 is preferably 2 inches wide and between 4 and 5 inches high, including the height of the lips 58 described below.

One or more ribs 55 may further connect the outside wall 51 to the inside wall 52, adding structural stability to the outside stringer 11. A notch 56 may be formed into the outside wall 51. The notch 56 provides a place to insert a pallet 10 tag (not shown), such as a radio frequency identification (“RFID”) tag, or a wireless (“WIFI”) tag. The pallet tag is placed in the notch 56 so that it does not protrude from the outside wall 51. The notch 56 may be sized to accommodate the desired pallet tag. The preferred heavy-duty pallet 10 has a notch that is 2.375 inches wide and 0.406 inches deep, accommodating a CONFIDEX model 3000072 or similar RFID tag. The preferred light-duty pallet 10 has a notch that is 1.375 inches wide and 0.25 inches deep, accommodating a CONFIDEX model HAO122B75 or similar RFID tag. The outside stringer 11 may have a plurality of screw bosses 57 formed onto the inner surfaces of the outside wall 51, inside wall 52 or both. The screw bosses 57 each receive a fastener used to secure a cap 61 onto either end of the outside stringer 11.

The outside wall 51 may comprise one or two lips 58 that extend vertically past the top wall 53, bottom wall 54, or both walls 53, 54. The lips 58 serve to abut the ends of the slats 13, retaining the slats 13 in position and preventing the slats 13 from hanging over the edge of the outside stringer 11. A lip 58 is preferably the same height as a slat 13 so it does not project above the face of the pallet 10. The number and orientation of the lips 58 will depend on the pallet 10 design: a single-faced flush pallet 10 may have a lip 58 on the top, and may also have a lip 58 on the bottom if slats 13 are to be attached thereto; a double-faced or reversible flush pallet 10 may have lips 58 on the top and bottom; a single-winged pallet 10 may have a lip 58 on the bottom; and a double-winged pallet 10 will not have any lips 58.

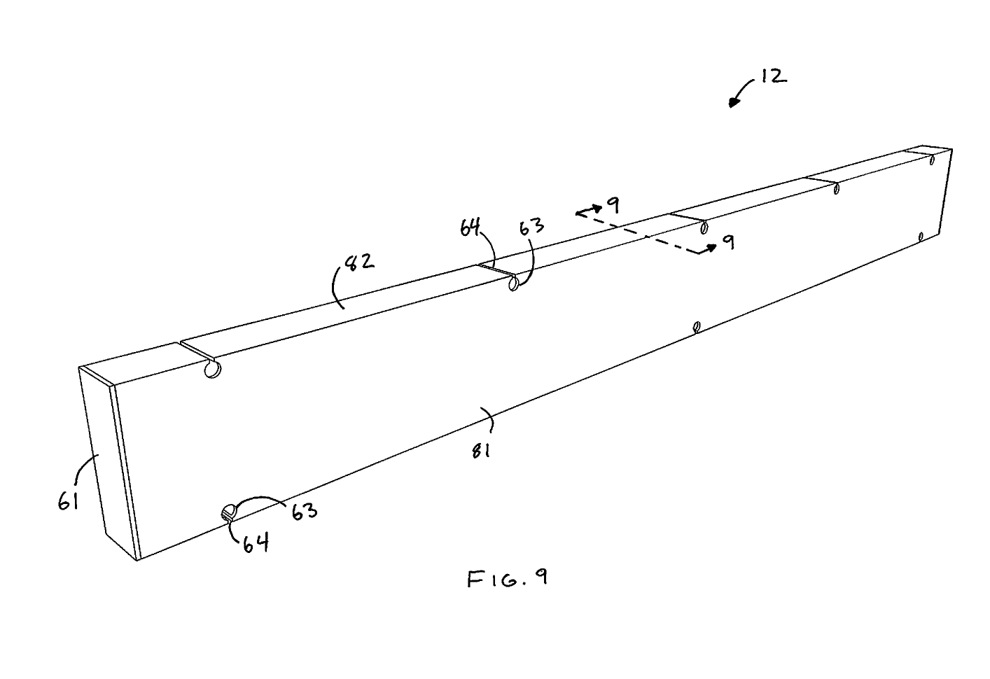

A plurality of grooves 62 are formed into the outside stringer 11. The grooves 62 project vertically inward from at least the top wall 53, and also from the bottom wall 54 if slats 13 are used to form a bottom face. As shown in FIGS. 6 and 8, one groove 62 is needed for each slat 13, so that the preferred outside stringer 11 has five grooves 62 in the top wall 53 and three grooves 62 in the bottom wall 54. A groove 62 is shaped to receive the projection 33 on a slat 13, so that the projection 33 fits tightly in the groove 62. Specifically, the groove 62 substantially encloses the tongue 35, coming into close proximity or contact with the neck 34 so that the tongue 35 can only move along its axis, which is parallel to line X in FIG. 2, and cannot rotate within the groove 62. In the preferred embodiment, the groove 62 comprises a circular punch 63 passing through the inside wall 52, and a channel 64 passing through the top wall 53 or bottom wall 54. The channel 64 starts at the inside wall 52 and extends to the lip 58 if there is one, or to the outside wall 51 if there is no lip 58. A second punch 63 may pass through the outside wall 51 if there is no lip 58. The grooves 62 are preferably uniformly spaced along the length of the outside stringer 11, with the grooves 62 for front and back slats 13 being located 2.5 inches inward from the ends of the outside stringer 11 so that the front and back slats 13 are flush with the ends of the stringers 11, 12.

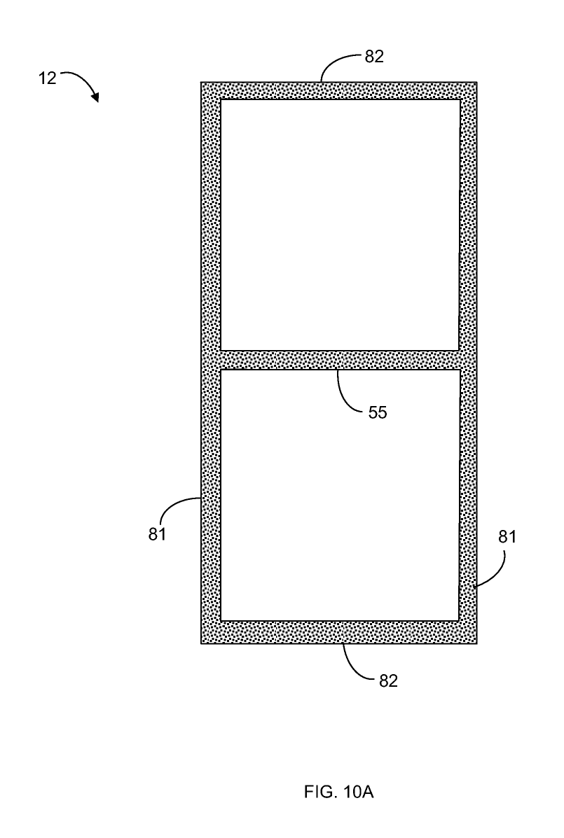

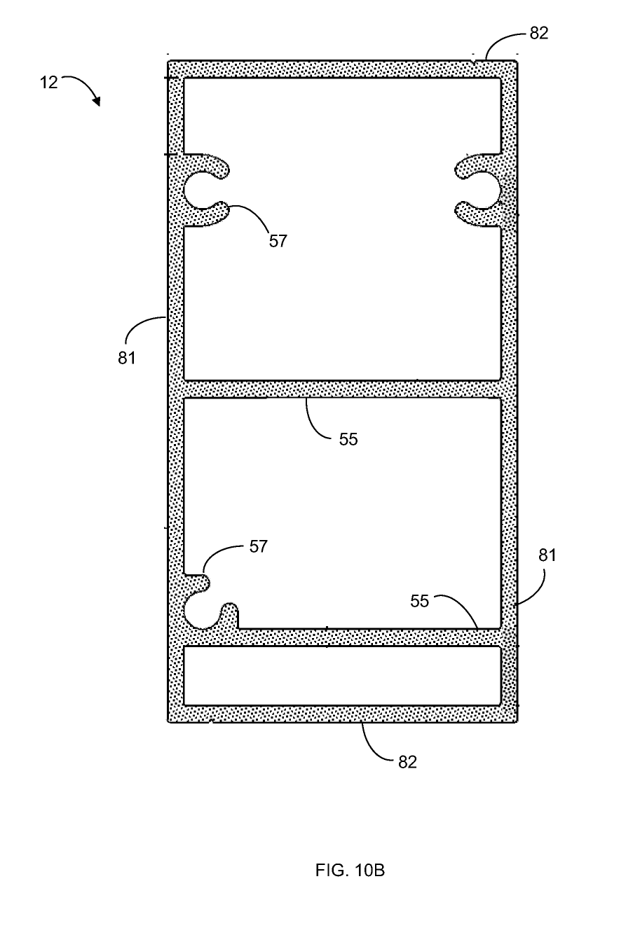

FIGS. 9-10B illustrate the preferred inside stringer 12. The inside stringer 12 has vertical walls 81 and horizontal walls 82 that form a rectangle. Preferably, the inside stringer 12 is 2 inches wide and between 3.75 and 4.75 inches high. Like the outside stringer 11, the inside stringer 12 may have screw bosses 57 for attaching caps 61 to the ends, and a rib 55 for reinforcing the structure. Preferably, the inside stringer 12 has a second rib 55 to add further stability, due to the added force exerted on the inside stringer 12 by heavy loads. Grooves 62 are formed into the inside stringer 12 as described above, so that the grooves 62 are aligned with the grooves 62 in the outside stringers 11.

The stringers 11, 12 and slats 13 may be molded, extruded, or otherwise die cast. Extrusion is preferable due to the workability of the preferred alloy and the much lower cost of producing extrusion dies over producing molds. The pallet 10 parts may be produced using as few as 2 extrusion dies, depending on the chosen pallet 10 design. For example, a double-wing pallet 10 has identical outside stringers 11 and inside stringer 12, so only 2 dies are needed—1 for the stringers 11, 12 and 1 for the slats 13. Preferably, however, there are 3 extrusion dies because the pallet 10 is flush, the design benefiting from two lips 58 on each outside stringer 11.

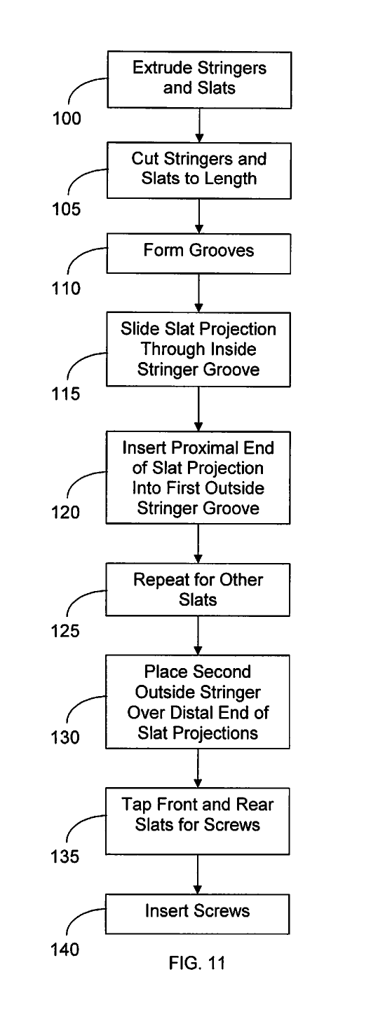

Referring to FIG. 11, three extrusion dies are used in a method of making the preferred pallet 10. The preferred aluminum alloy is extruded 100 through the dies, creating 8 feet of outside stringer 11 material, 4 feet of inside stringer 12 material, and 26.5 feet of slat 13 material. The parts are then cut 105 to length: 2 outside stringers 11 are cut to 48 inches in length, 1 inside stringer 12 is cut to 48 inches in length, and 8 slats 13 are cut to 39.75 inches in length. The grooves 62 are then formed 110 into the stringers 11, 12, with 5 grooves 62 on the top and 3 grooves 62 on the bottom. Most preferably, the grooves 62 are formed 110 using a 2-part process. First, the punches 63, preferably about 0.875 in diameter, are formed into the inside walls 52 of the outside stringers 11, and into both vertical walls 81 of the inside stringer 12. Then, the channels 64 are formed, each having a width of about 0.125 inches. The channels 64 on the outside stringers 11 extend from the punches 63 to the lips 58, and the channels 64 on the inside stringer 12 extend fully along the horizontal walls 82 from punch 63 to punch 63. The grooves 62 may be formed one at a time, but preferably grooves 62 that are horizontally aligned on a stringer 11, 12 are formed simultaneously using a computer numerical controlled (“CNC”) machine tool. This is done to minimize the chance of misalignment of the grooves 62, so that the slats 13 may interlock precisely with the stringers 11, 12.

Once the grooves 62 are formed 110, a first slat 13 is taken up and its projection 33 is slid 115 through one of the grooves 62 in the inside stringer 12. Then, the proximal end of the first slat's 13 projection 33 is inserted 120 into the groove 62 in the first outside stringer 11 that aligns with the groove 62 used on the inside stringer 11. The projection 33 is inserted 120 until the slat body 30 abuts one of the lips 58. The sliding 115 and insertion 120 are then repeated 125 with the other slats 13, until each groove 62 in the inside stringer 12 and first outside stringer 11 contains a projection 33 from a slat 13. Then, the second outside stringer 11 is placed 130 over the slat 13 projections 33 at the slats' distal ends, by feeding the projections 33 into the grooves 62 on the second outside stringer 11.

The parts may then be secured in place by tapping 135 screw holes in the front slats 13a and rear slats 13b. See FIGS. 1 and 2. In the preferred embodiment, only 12 screws are needed: 1 screw for each stringer 11, 12 in each of the 2 front slats 13a and 2 rear slats 13b. Preferably, two of the screw holes are tapped 135 within 0.25 inches of each end of the slats 13a, 13b so that the screw may catch a portion of a screw boss 57 to improve its hold in the outside stringers 11. The third screw hole is preferably tapped 135 at the midpoint of the slat 13a, 13b so that the inside stringer 12 is secured substantially centrally between the slats 13. Once the screw holes are tapped 135, screws 83 are screwed into the slats 13a, 13b and stringers 11, 12 to finish the pallet 10. Optionally, caps 61 may be attached to the ends of the stringers 11, 12. The caps 61 are preferably attached using screws that extend into the screw bosses 57.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

What is claimed is:

1. A pallet comprising:
a plurality of substantially aluminum slats, each slat comprising:
a slat body having a length, a width, and a height, an outer surface, and an inner surface separated from the inner surface by the height; and
a projection connected to the inner surface of the slat body, the connection extending along the length of the slat body;
a substantially aluminum first outside stringer having a length, a width, and a height, a top outside edge, and a bottom outside edge, the first outside stringer comprising:
a plurality of grooves each shaped to receive the projection of one of the slats such that the projection fits tightly and cannot rotate within the groove, causing the slats to interlock with the first outside stringer; and
a first lip projecting from the top outside edge along the length of the first outside stringer and perpendicular to the grooves, against which one or more of the slats abut to prevent the slats from extending beyond the top outside edge when the slats are interlocked with the first outside stringer;
a substantially aluminum second outside stringer having a length, a width, and a height, a top outside edge, and a bottom outside edge, the second outside stringer comprising:
a plurality of grooves each shaped to receive the projection of one of the slats such that the projection fits tightly and cannot rotate within the groove, causing the slats to interlock with the second outside stringer; and
a first lip projecting from the top outside edge along the length of the second outside stringer and perpendicular to the grooves, against which one or more of the slats abut to prevent the slats from extending beyond the top outside edge when the slats are interlocked with the second outside stringer; and
at least one substantially aluminum inside stringer having a length, a width, and a height, and comprising a plurality of grooves each extending through the width of the inside stringer and aligned with one of the grooves on each of the outside stringers, and each groove shaped to receive the projection of one of the slats such that projection fits tightly and cannot rotate within the groove, causing the slats to interlock with the inside stringer;
the interlocking of the slats with the first and second outside stringers and the inside stringer allowing the pallet to be assembled without permanent attachment of the slats to the stringers and without securing each slat to the stringers with one or more fasteners.

2. The pallet of claim 1 wherein the projection comprises a neck connected to the inner surface of the slat body, and a tongue connected to the neck and being substantially wider than the neck.

3. The pallet of claim 2 wherein the tongue is at least twice as wide as the neck.

4. The pallet of claim 2 wherein the groove comprises a channel and a punch connected to the channel and being substantially wider than the channel.

5. The pallet of claim 1 wherein the plurality of slats comprises at least four slats and the plurality of grooves comprises at least four grooves, and wherein at least two of the slats interlock with the first and second outside stringers and the inside stringer and abut the first lip of each of the outside stringers to form a top face, and at least two of the slats interlock with the outside stringers and the inside stringer to form a bottom face.

6. The pallet of claim 5 wherein:
the first outside stringer further comprises a second lip projecting from the bottom outside edge along the length of the first outside stringer and perpendicular to the grooves, against which one or more of the slats abut to prevent the slats from extending beyond the bottom outside edge when the slats are interlocked with the first outside stringer;
the second outside stringer further comprises a second lip projecting from the bottom outside edge along the length of the second outside stringer and perpendicular to the grooves, against which one or more of the slats abut to prevent the slats from extending beyond the bottom outside edge when the slats are interlocked with the first outside stringer; and
the slats that form the bottom face abut the second lip of each of the outside stringers.

7. The pallet of claim 6 having more than four slats, wherein the slats include two front slats and two rear slats, each of the front and rear slats being attached to each of the first outside stringer, second outside stringer, and inside stringer by a plurality of removable fasteners after the slats are interlocked with each of the first outside stringer, the second outside stringer, and the inside stringer.

8. The pallet of claim 1 wherein each of the first and second outside stringers comprise a notch on an outside wall of each of the outside stringers, the notch being configured to receive a pallet tag.

9. The pallet of claim 1 wherein one or more of the grooves of each outside stringer extend along the width of the outside stringer up to the first lip.

10. A pallet comprising:
a plurality of substantially aluminum slats, each slat comprising:
a slat body having a length, width, and height, an outer surface, and an inner surface; and
a projection connected to the inner surface of the slat body, the connection extending along the length of the slat body;
a first outside stringer, a second outside stringer, and at least one inside stringer, each being substantially aluminum and comprising a plurality of grooves shaped to receive the projection of one of the slats such that the slats interlock with the outside stringers and the inside stringer and the pallet is assembled without welds.

11. The pallet of claim 10 further comprising at least one lip extending from each of the first and second outside stringers to retain the slats between the lips of the first and second stringers when the slats are interlocked with the outside stringers and the inside stringers.

12. The pallet of claim 10 wherein each of the grooves of the first and second outside stringers and inside stringers are shaped such that the projection fits tightly and cannot rotate within the groove.

13. A method of making an aluminum pallet, the method comprising:
forming, out of a substantially aluminum material, a first outside stringer, a second outside stringer, at least one inside stringer, and a plurality of slats, wherein:
each of the slats comprises a slat body and a projection extending out from and along the length of the slat body, the projection having a proximal end and a distal end;
the first outside stringer, second outside stringer, and inside stringer all comprise a plurality of grooves each configured to receive the projection of one of the slats such that the projection fits tightly and cannot rotate within the groove, each groove of the first outside stringer aligning with one of the grooves of the second outside stringer and one of the grooves of the inside stringer; and
each of the first and second outside stringers comprise at least one lip against which one or more of the slats abut so that the slats are retained between the lips of the first and second outside stringers when the slats are interlocked with the first and second outside stringers; and
interlocking each of the slats with each of the first outside stringer, second outside stringer, and inside stringer to assemble the pallet without permanent attachment of the slats to the stringers and without securing each slat to the stringers with one or more fasteners.

14. The method of claim 13 wherein forming the first outside stringer, second outside stringer, inside stringer, and slats comprises extruding the first outside stringer, second outside stringer, inside stringer, and slats from at least two extrusion dies.

15. The method of claim 14 wherein:
the grooves of the first and second outside stringers each comprise a punch and a channel connected to the punch and extending from the punch to the lip;
the grooves of the at least one inside stringer comprise two punches and a channel connecting the punches; and
forming the first outside stringer, second outside stringer, and inside stringer further comprises forming the punches and channels of the grooves after extruding the first outside stringer, second outside stringer, and inside stringer.

16. The method of claim 13 wherein the substantially aluminum material comprises 6005-T6 aluminum alloy.

17. The method of claim 13 wherein interlocking each of the slats with each of the first outside stringer, second outside stringer, and inside stringer comprises:
for each slat, sliding the projection of the slat through one of the grooves of the inside stringer;
inserting the proximal end of the projection of each slat into the aligned groove of the first outside stringer; and
placing the second outside stringer onto the slats such that the distal ends of the projections of the slats are inserted into the grooves of the second outside stringer and the slats are retained between the lips of the first and second outside stringers.

18. The method of claim 17 wherein interlocking each of the slats with each of the first outside stringer, second outside stringer, and inside stringer further comprises removably fastening two or more of the slats to each of the first outside stringer, second outside stringer, and inside stringer.

19. The method of claim 13 wherein:
the projection comprises a neck and a tongue attached to the neck, the tongue being wider than the neck; and
the groove comprises a channel and a punch connected to the channel, the punch being wider than the neck, such that the neck may pass through the channel as the tongue passes through the punch.

20. The method of claim 13 further comprising attaching a pallet tag to the first outside stringer.
